(19) United States
(12) Patent Application Publication
(10) Pub. No.: US 2009/0225073 A1
(43) Pub. Date: Sep. 10, 2009

(54) Method for Editing Gridded Surfaces

(75) Inventor: Robert Allison Baker, III, Sugar Land, TX (US)

Correspondence Address: TIM SHEN LAW OFFICE, 14125 MEMORIAL DR., SUITE 106, HOUSTON, TX, 77079, US

(73) Assignee: SEISMIC MICRO-TECHNOLOGY, INC., Houston, TX (US)

(21) Appl. No.: 12/041,767

(22) Filed: Mar. 4, 2008

(51) Int. Cl. G06T 15/00

(52) U.S. Cl. 345/419

(57) ABSTRACT

A method of editing a surface representing a quantitative field is disclosed which facilitates getting a surface to conform to a required shape. In embodiments, the methods revise a surface display substantially in real time by altering a predetermined visual characteristic of the displayed surface as a function of changed original values, the predetermined visual characteristic comprising at least one of a contour line representative of a set of the changed original values or a one-to-one color mapping between a changed original value and color.

### FIELD OF INVENTION

The invention relates generally to the field of representing a continuous quantitative field, such as terrain elevations, on a visible map. In particular, it relates to the construction, manipulation, and display of these types of maps using a system that revises a displayed surface substantially in real time by altering one or more predetermined visual characteristics of the displayed surface as a function of changed original values, preferably interactively.

### BACKGROUND OF THE INVENTION

In its various embodiments, this invention may be applied to various maps, e.g. topographic and bathymetric maps, as well as to graphic representations of quantitative fields that necessitate approximation.

Graphic representation of quantitative fields is important for many fields of study. For example, weather maps showing barometric pressure are a commonly seen graphic representation of quantitative fields (e.g., FIG. 1). Topographic maps (e.g., FIG. 2) are another common graphic representation of a quantitative field. Lines on topographic maps are called “contour lines” and represent points of equal elevation. Any movement along a contour line will entail no change in elevation, while any movement away from a contour line will entail movement either up hill or down hill. A bathymetric map (e.g., FIG. 3) is similar to a topographic map.

Contour lines are usually smooth because 1) they are the result of averaging and interpolating data points and 2) they are conceived of as representing continuous surfaces, which conception encourages the mapper to construct them as smooth. There are two principal circumstances in which contour lines are not smooth: 1) where very detailed surveys are conducted and 2) where a contour follows an irregular boundary, e.g. a shoreline or elevations such as depth.

Elevations of buried surfaces are commonly mapped to produce what are termed “structure maps” by geoscientists (e.g., FIG. 4). Measurements of physical phenomena such as porosity can also be portrayed in contour maps (e.g., FIG. 5). One critical aspect of maps of quantitative field data is that they are almost always derived from point data and are almost always the result of computation. For example, elevation may be measured at the top of a hill and at its bottom, and elevations between these points can be computed by interpolation.

Because of the cost, data typically cannot be collected everywhere. Judgment is used to decide where to interpolate and where to collect new data. Interpolation is almost always required and is universally accepted. Interpolated values can be represented by colors rather than by contours, as illustrated in FIG. 6. As used herein, “color” and “colors” include gray-scale as well as color spectrum representations.

FIGS. 7 and 8 illustrate the use of computer surfaces for design of physical objects or for creating animation content, not for representation of quantitative fields generally. The surface in FIG. 8 is a distortion of the surface in FIG. 7, and coloration depends on the original color of the surface, in this case a solid color, the lighting, and the point of view. The coloration is intended to imitate what the eye would see, given the shape and color of the surface. Changes in elevation cause changes in coloration primarily by changing the angle between the surface and the viewer. The intent of such a representation is to imitate what the eye would see, not to portray a quantitative field.

The color representations of FIG. 6 differ from coloration illustrated in FIGS. 7 and 8. The colors in FIG. 6 are directly dependent on the elevation, or other quantitative field value, of the point where the color is shown. With the appropriate color table, shown at right in FIG. 6, one can convert a color to a field value.

Contours and colors can also be combined. Color choice and style of display are typically chosen for emphasis, but coloration is typically not arbitrary. Coloration usually has an explicit dependency on field values for the maps this invention is intended to enhance.

If a person making a map wants areas shown as connected, s/he must either alter the algorithm or add data points that will cause the algorithm to connect the two areas as desired. Either method is typically a matter of trial and error. In the more common case, the map maker uses the same algorithm, or slight variations, for all maps because s/he understands its behavior. The job then consists of adding points, recomputing the map, adding or moving points, recomputing the map, and so on until the display is as desired. Maps require this kind of adjustment because there is nearly always other information, not represented by the data points, that suggests the nature of the geometry. The map maker's job is to include this other information without violating the known, directly pertinent, data points.

The most common method for mapping quantitative data creates “pseudo data” points at Cartesian locations. The method goes under the name of “gridding” because a grid of pseudo data points is created. Values at data points are used to estimate values at grid points, and map values are computed by interpolation between grid points.

Contours are almost always generated by means of a grid. The grid may be explicit or it may be deleted once the contours are drawn, but where contours are present, a grid of some nature preceded them. Contours are, in effect, traces of constant color interpolated from the grid. A grid is first generated to represent the surface loosely, and then values are interpolated between the grid points to represent the surface in detail. Contours are often used without reference to a grid because they are usually more expressive than grids.

### BRIEF DESCRIPTION OF THE DRAWINGS

FIG. 1 is a typical weather map, shown for the purpose of illustrating this use of contour lines to represent a quantitative field of numbers;

FIG. 2 is a typical topographic map, shown for the purpose of illustrating another use of contour lines to represent a quantitative field of numbers;

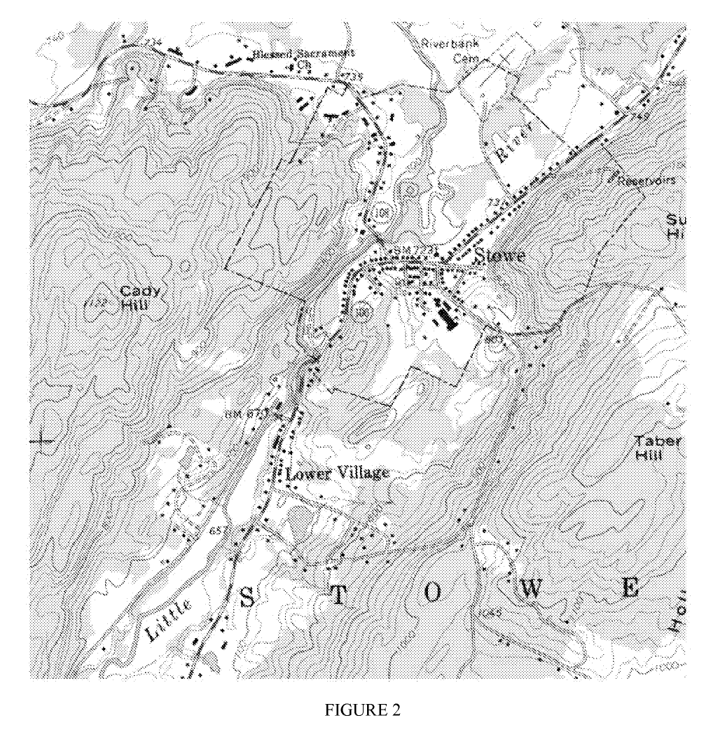

FIG. 3 is a typical bathymetric map, shown for the purpose of illustrating another use of contour lines to represent a quantitative field of numbers;

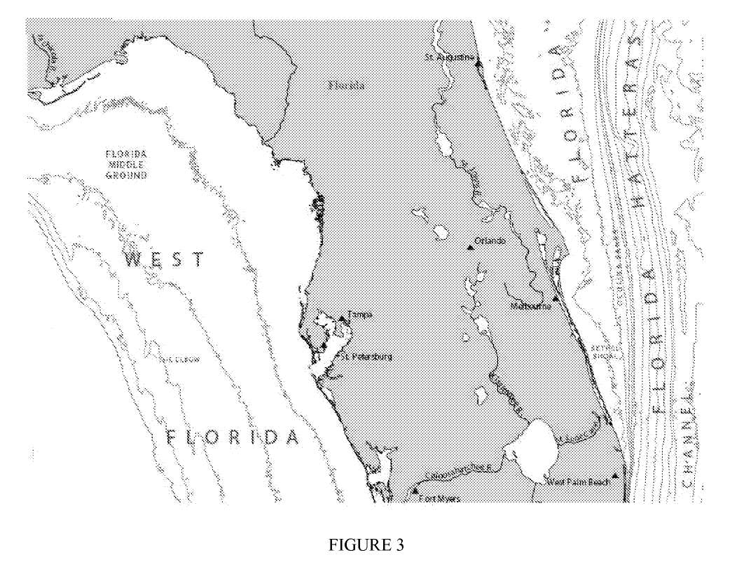

FIG. 4 is a typical “structural” map, shown for the purpose of illustrating the use of contour lines to represent a quantitative field that is not at the surface of the Earth;

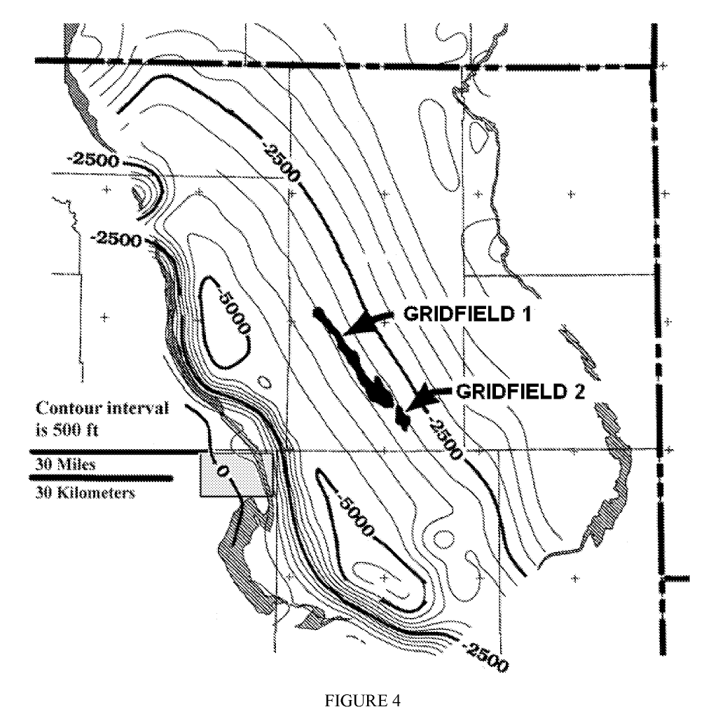

FIG. 5 is a typical geoscience contour map, shown for the purpose of illustrating the use of contour lines to represent a field of measurements rather than elevation;

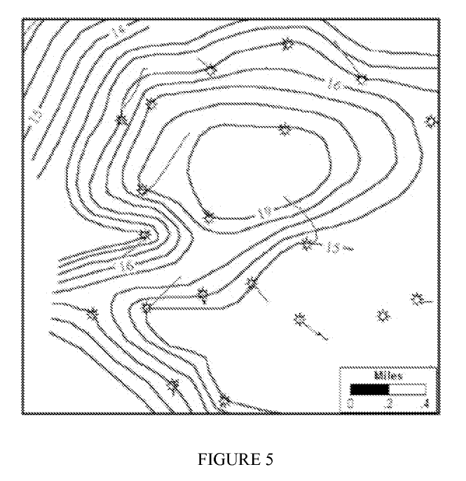

FIG. 6 is a typical geoscience map, shown for the purpose of illustrating the use of coloration lines to represent a quantitative field of numbers;

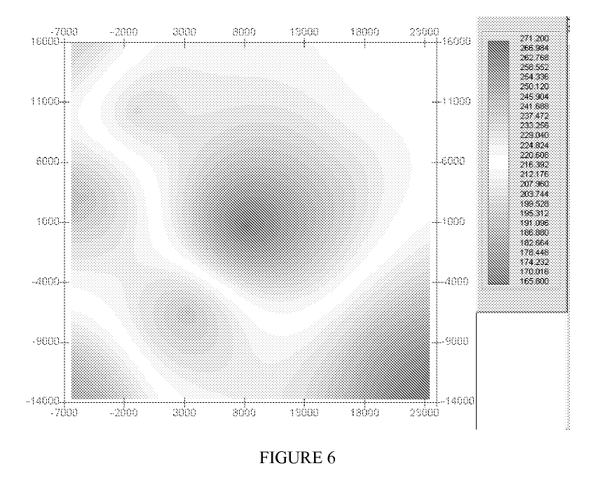

FIG. 7 is a typical geoscience map, shown for the purpose of illustrating the use of both contour lines and coloration to represent a quantitative field of numbers with “grid points” shown;

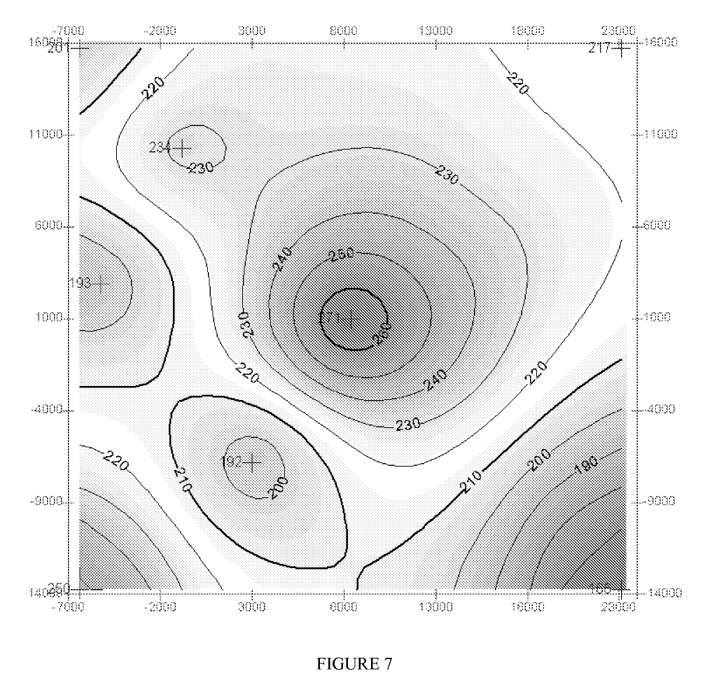

FIG. 8 illustrates the difference between nodes in graphics arts and the surface those nodes generate;

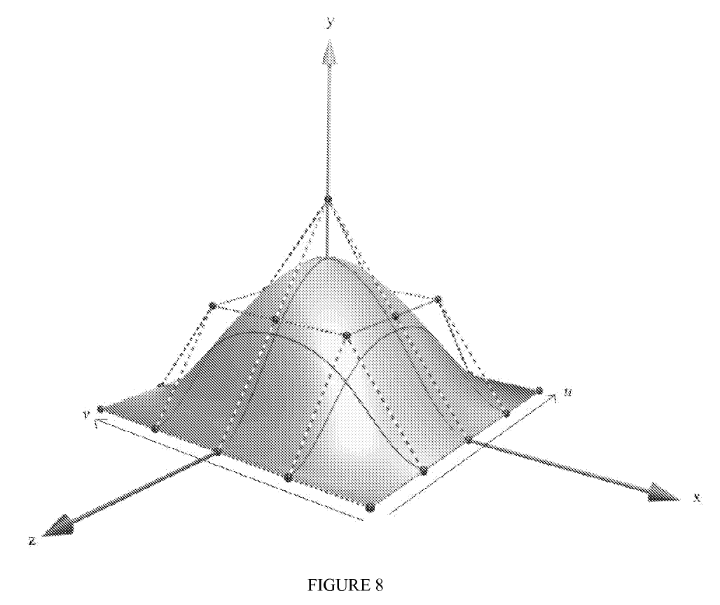

FIG. 9 illustrates an exemplary system;

FIG. 10 illustrates the range of effect of the editing tool, with exemplary data points indicated by a “+” in the figure;

FIG. 11 illustrates an exemplary graphical user interface useful to manipulate operable options; and

FIG. 12 is a flowchart of an exemplary methods.

### DETAILED DESCRIPTION OF A PREFERRED EMBODIMENT

A basic facet of a gridding algorithm is that the algorithm itself “falsifies” the surface it represents. It typically does so objectively, but the surface is nevertheless falsely represented because the representation between data points is a result of calculation rather than observation. The fact that a pre-determined mathematical series of operations are used to create the surface in no way guarantees that the rendered surface is accurate.

In its various embodiments, the methods of this invention are useful to aid in representation of quantitative fields such as in geoscience. In their various embodiments, these methods provide an expedient means of manipulating and correcting grids and therefore provide methods for expediently correcting maps. For example, a geoscientist editing a map will typically have other information not represented by specific data points shown in that map that can be used to improve the map. If, for example, data point values are taken from readings taken from wells and other information in the wells indicated that the rocks at these locations were part of a beach, the geoscientist would know that beaches are typically elongate, not ovoid, in shape and would change the map to reflect that understanding. In addition to information from wells, s/he may have seismic information, which is like an acoustic x-ray of the Earth, or magnetic field data, that gives information about shape.

A topographic surface is an example of three dimensional data when the surface is represented by points of elevation. By way of example, each point in a topographic surface representation has an X and Y coordinate corresponding to its position in a single plane as represented on the map. However, for three dimensional data, each point also has an elevation or depth, represented by a Z axis value. This Z axis value is often difficult to represent in a two-plane representation of the three-dimensional data. In a preferred embodiment, the method facilitates editing one dimension of three-dimensional numerical data, e.g. the Z axis data.

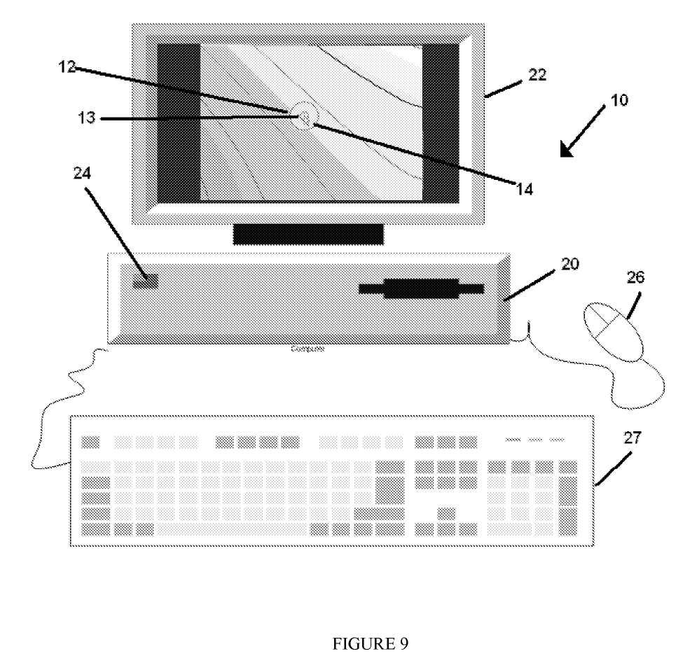

Referring now to FIG. 9, system 10 is adapted for editing a surface, e.g. a topography displayed on display 22. System 10 comprises computer 20; display 22, which is operatively in communication with computer 20; data store 24; and, typically, pointing device 26, e.g. a mouse or light pen.

Computer 20 is typically a personal computer running an appropriate version of the Microsoft® Windows® operating system such as Windows XP® or Windows Vista®, although the system and its methods are not limited to such configurations. In a preferred embodiment, computer 20 comprises at least 512 KB of random access memory and a CPU executing at 1.00 gigahertz or higher.

First set of data 30 (not shown in the figures) representing a topology are available to computer 20. First set of data 30 may reside on data store 24 or may be obtained from another source, e.g. a local or wide area network source (not shown in the figures).

Display software 40 (not shown in the figures) is operatively resident in computer 20 and is adapted to render a display of the topology on display 22 based on first set of data 30. As will be familiar to those of ordinary skill in these arts, display software 40 may comprise standard graphics software such as is commonly obtained for use with personal computers.

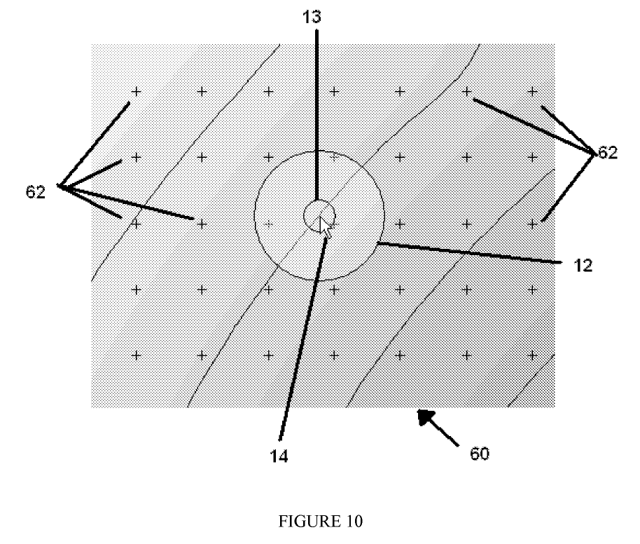

Referring additionally to FIG. 10, editing software 50 (not shown in the figures) is also operatively resident in computer 20 (FIG. 9). Editing software 50 is adapted to generate a set of conical values reflecting data in three dimensions using data based on first set of data 30 (not shown in the figures), where the apex of the generated conical values is located at focal point 13. In the preferred embodiment, editing software 50 modifies the topology as a function of a distance of a predetermined subset of first set data 30 from focal point 13 in each of three axes. Editing software 50 changes a predetermined subset of first set of data 30 based on the modified topology. Editing software 50 may also change one or more characteristics of the resulting contour lines of the modified topology, e.g. color, shape, thickness, and the like, or a combination thereof.

If pointing device 26 is present, a system user can use pointing device 26 to communicate the location of the desired focal point 13 to editing software 50. As will be familiar to those of ordinary skill in these arts, pointing device 26 may be a mouse, trackball, lightpen, keyboard 27, or the like, or a combination thereof, and typically its movement results in a corresponding movement of cursor 14 on display 22.

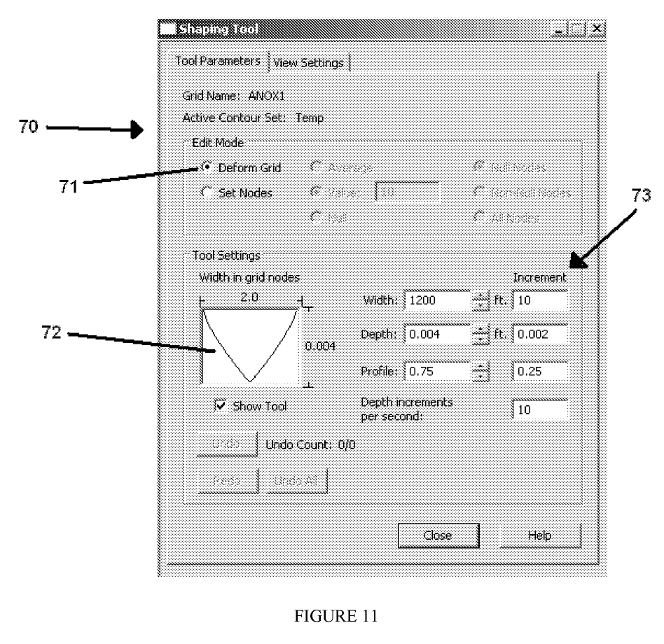

FIG. 11 illustrates an exemplary graphical user interface used to manipulate options in a preferred embodiment. Options are in shown the lower left of FIG. 11, within the box titled “Tool Settings.” In this illustration, “Deform Grid” option 71 enables use of the methods of this invention. Diagram 72 shows a profile of the distortion surface. A cursor option area is located at the center of diagram 72. In this example, the degree of distortion decreases away from the center proportional to the profile shown. Maximum distortion is at the center, and distortion at the edge of the range is zero.

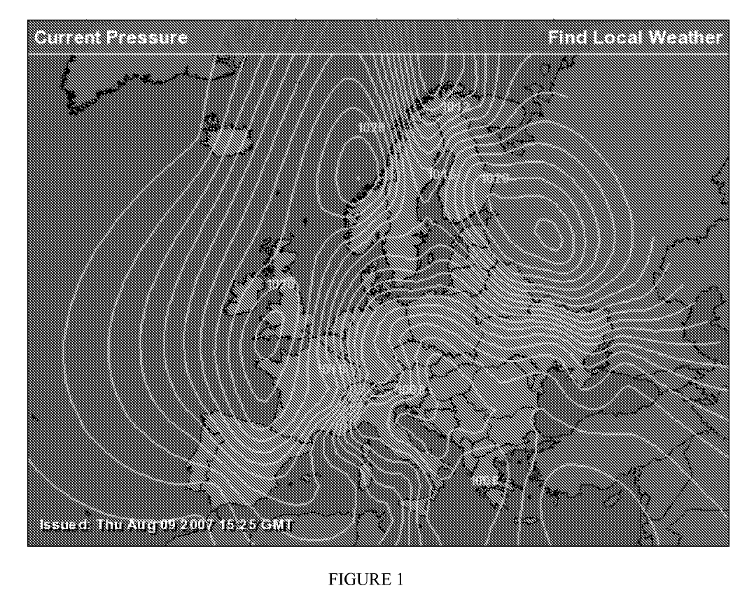

Numerical effect parameters 73 may configure one or more numerical effects. “Width” is the diameter of the tool range as illustrated in FIG. 10. Increasing the number will cause the range to increase. “Depth” is the amount of change at the center that will result from use of pointing device 26 (FIG. 1), e.g. by one click of the mouse.

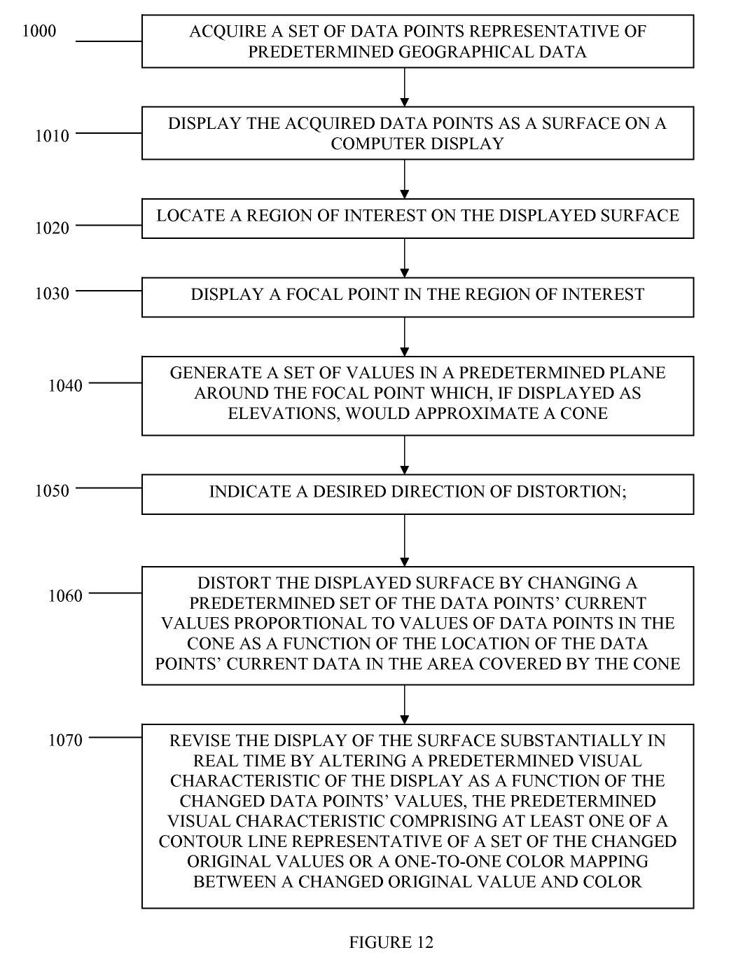

In the operation of a preferred embodiment of the invention, referring to FIG. 12, generally, data representative of geographically distributed data may be edited by acquiring a set of data points 30 (not shown in the figures) representative of predetermined geographical data. Typically, non-estimated values are not changed. Instead, the estimated and conceptual nature of most contour lines is used for the calculations. These data points 30 typically comprise data of interest geologically such as data representative of elevation, temperature, magnetic permeability, porosity at a given depth, or the like, or a combination thereof.

Once acquired, acquired data points 30 are displayed as a surface on display 22 (FIG. 9). In certain embodiments a graphic image is displayed concurrently with the coloration or contour display in order to provide guidance to the editor of the surface. For example, an aerial photograph may be displayed beneath the contour line

A region of interest is located on the displayed surface, such as by using pointing device 26 (FIG. 9). Focal point 13 (FIG. 9; FIG. 10) is displayed in the located region of interest. Focal point 13 can take the form of a graphic overlaid onto the displayed surface. In a preferred embodiment, a map maker uses cursor 14 (FIG. 9; FIG. 10) to locate an area to be edited, e.g. area 60 (FIG. 10). Grid values within range of cursor 14 may be changed according to user preferences, e.g. user defined settings such as are illustrated in FIG. 12.

A second set of values 31 (not shown in the figures) is generated in a predetermined plane around focal point 13 (FIG. 9; FIG. 10). These values, if displayed as elevations, would approximate a cone. In a preferred embodiment, the predetermined plane around focal point 13 is a circular area.

A direction of desired distortion is then indicated, typically by using pointing device 26 (FIG. 9) to indicate a desired distortion direction in a predetermined plane with respect to the displayed surface. Once indicated, the displayed surface is distorted by changing the original values in proportion to values in the cone dependent on the location of the original data in the area covered by the cone. Distorting the surface typically comprises changing the original values of data values 30 (not shown in the figures) contained in the cone by performing a mathematical operation on the original values, e.g. addition, subtraction, multiplication, and/or division. In certain embodiments, pointing device 26 is moved until the surface is distorted into a smooth shape as required by the mapper. This smoothing operation also fits a mathematical surface to the points within range and then adjusts those points so that they more closely match the mathematical surface.

Typically, focal point 13 (FIG. 9; FIG. 10) is moved in a direction, using pointing device 26. The rate of movement of focal point 13 may also be determined and the cone shaped as a function of the direction and the rate of movement.

Additionally, the distorted surface may be conformed to the underlying graphic image according to a predetermined relationship between the displayed surface and the underlying graphic image, e.g. matching the changed subset and the underlying graphic image, utilizing a geometric relationship between the changed subset and the underlying graphic image, or the like, or a combination thereof.

The display of the surface is revised substantially in real time by altering a predetermined visual characteristic of the display as a function of the changed original values, the predetermined visual characteristic comprising at least one of a contour line representative of a set of the changed original values or a one-to-one color mapping between a changed original value and color.

In a further preferred embodiment, an affected range may be shown on a map, e.g. area 60 (FIG. 10). A predetermined number of grid nodes 62 (some of which are called out in FIG. 10 as “62”) falling within circle 12 (FIG. 10) surrounding cursor 14 (FIG. 10) are modified when the user manipulates pointing device 26 (FIG. 9). In a preferred embodiment, all such grid nodes 62 are modified. Grid nodes 62 may continue to be modified so long as pointing device 26 indicates selection, e.g. by depressed a mouse button. For example, clicking on a left mouse button of pointing device 26 may distort the field downward (decreasing values near cursor 14) while clicking on a right mouse button of pointing device 26 may distort the field upward (increasing values near cursor 14).

It will be understood that various changes in the details, materials, and arrangements of the parts which have been described and illustrated above in order to explain the nature of this invention may be made by those skilled in the art without departing from the principle and scope of the invention as recited in the appended claims.

We claim:

1. A method of editing data representative of geographically distributed data, comprising:
a. acquiring a set of data points representative of predetermined geographical data;
b. displaying the acquired data points as a surface on a computer display;
c. locating a region of interest on the displayed surface;
d. displaying a focal point in the region of interest;
e. generating a set of values in a predetermined plane around the focal point which, if displayed as elevations, would approximate a cone;
f. indicating a desired direction of distortion;
g. distorting the displayed surface by changing a predetermined set of the data points' current values proportional to values of data points in the cone as a function of the location of the data points' current data in the area covered by the cone; and
h. revising the display of the surface substantially in real time by altering a predetermined visual characteristic of the display as a function of the changed data points' values, the predetermined visual characteristic comprising at least one of a contour line representative of a set of the changed original values or a one-to-one color mapping between a changed original value and color.

2. The method of claim 1, wherein the predetermined geographical data comprise data representative of at least one of elevation, temperature, magnetic permeability, or porosity at a given depth.

3. The method of claim 1, wherein distorting the surface further comprises changing the original values of data values contained in the cone by performing a mathematical operation on the original values as a function of the location of the data points' current data in the area covered by the cone.

4. The method of claim 1, wherein the predetermined plane around the focal point defines a circular area.

5. The method of claim 1, further comprising:
a. locating the region of interest on the displayed surface using a pointing device; and
b. using the pointing device to indicate the desired distortion direction in a predetermined plane with respect to the displayed surface.

6. The method of claim 5, wherein the pointing device comprises at least one of a mouse, light pen, track ball, or keyboard.

7. The method of claim 1, further comprising:
a. integrating the displayed surface with a graphic image; and
b. deriving a predetermined configuration from the graphic image.

8. The method of claim 7, further comprising conforming the distorted surface to the underlying graphic image according to a predetermined relationship between the displayed surface and the underlying graphic image.

9. The method of claim 8, wherein the predetermined relationship comprises at least one of (i) a match between the changed subset and the underlying graphic image or (ii) a geometric relationship between the changed subset and the underlying graphic image.

10. The method of claim 1, wherein the display of the surface is superimposed on a graphic.

11. The method of claim 10, wherein the graphic comprises a photograph.

12. The method of claim 1, further comprising:
a. moving the focal point in a direction;
b. determining a rate of movement of the focal point; and
c. shaping the cone as a function of the direction and the rate of movement.
